(19) United States
(12) Patent Application Publication
(10) Pub. No.: US 2013/0018758 A1
(43) Pub. Date: Jan. 17, 2013

(54) QUIDLR

(71) Applicants: RAGHURAM BALASUBRAMANIAN, Orange, CA (US); Peachawat Peachavanish, Long Beach, CA (US); Patrick Eger, Irvine, CA (US)

(72) Inventors: RAGHURAM BALASUBRAMANIAN, Orange, CA (US); Peachawat Peachavanish, Long Beach, CA (US); Patrick Eger, Irvine, CA (US)

(21) Appl. No.: 13/183,738

(22) Filed: Jul. 15, 2011

(51) Int. Cl. G06Q 30/00

(52) U.S. Cl. 705/26.41

(57) ABSTRACT

Embodiments of systems and methods are described. These embodiments may be used to facilitate an electronic payment or request for electronic payment for real-time transactions. In particular, the embodiments comprise a hand-held communication device associated with a payer, an electronic device associated with a payee and an application server associated with an electronic payment transaction application. The hand-held communication device is adaptable to execute the application software that is configured to generate or read a machine readable barcode. The electronic device is also adaptable to execute the application software which is configured to scan or capture the machine readable barcode. The application server is configured to facilitate the electronic payment between the hand-held communication device and the electronic device. The machine readable barcode is generated with a rapidly expiring timestamp which allows the payer and payee to conduct the real-time electronic payment transaction in a secure and cost effective way.

### BACKGROUND OF THE INVENTION

1. Technical Field of the Invention

The present embodiment relates in general to systems and methods for conducting payments using mobile devices. More specifically, the present invention relates to improved systems and methods for conducting payments for goods/services with mobile devices in a secure, cost effective manner.

2. Description of the Related Art

The rapid advances in electronic technology have led to the development of improved and highly efficient mobile device payment methods. Instead of paying with cash, check or credit cards, a consumer can use a mobile phone to pay for a wide range of services and digital or hard goods such as payment for tolls, parking meters, Point of sale (POS) terminals etc. However, most of the payment methods lack the capability to efficiently deliver the most secure and convenient payment methods.

Currently, the mobile systems for payments and financial transactions are woefully inefficient. Mobile payment systems normally require a mobile or wireless network which makes the transaction less secure since the data will be transferred across these networks.

Conventional methods for conducting mobile payments have considerable drawbacks. For example, these methods operate with mobile communication devices that implement additional software and hardware functionality, such as barcode scanning technology. Another major drawback in the existing methods is that these methods are uni-directional, text-only and do not use graphic images to convey data about a transaction. Further, the cost for the hardware and infrastructure facilities required to implement these methods is very high. These systems also require a password such as a personal identification number associated with a customer to be obtained via keypad or touchpad of the mobile payment device. Finally, these systems are not real-time or completely automated systems. Most of these methods necessitate the customer's credentials to be transferred through a network for verification, which allows unauthorized persons to crack the details creating a risk of insecure transactions and identity theft.

Therefore, there is a need for a system that will provide a cost effective and secure way of making payments. Such a system would use an efficient mobile payment method that does not require any additional hardware. Further, such a needed system would be able to adapt to the add-on changes in the software or hardware without making any changes or adding overhead to the existing infrastructure. Such a system would be simple, inexpensive and would provide a real-time payment to the user.

### SUMMARY OF THE INVENTION

To minimize the limitations found in the prior art, and to minimize other limitations that will be apparent upon the reading of the specifications, preferred embodiment of the present invention provides a system for facilitating real-time transactions via an application software. The system comprises a hand-held communication device associated with a payer, an electronic device associated with a payee and an application server associated with the application software.

In an electronic payment transaction, the hand-held communication device is adaptable to execute the application software that is configured to generate a machine readable barcode. The electronic device is adaptable to execute the application software which is also configured to read a machine readable barcode. The payer may utilize a registered account to login to the application software for initiating the electronic payment. If not previously registered, an account to login to the application software may also be registered at the time of the transaction. The payment information may be transmitted from the application software to the application server. The application server generates a unique identifier in response to the payment information from the application software. The unique identifier is received by the application software and the application software generates the machine readable barcode by encoding the unique identifier. The payer provides the machine readable barcode to the payee and the payee scans the machine readable barcode utilizing the electronic device. The electronic device utilizes the application software to resolve the machine readable barcode into the unique identifier. The unique identifier and payment information are sent to the application server by the application software to process the real-time transaction. The application server is configured to facilitate an electronic payment between the hand-held communication device and the electronic device. The machine readable barcode is generated with a rapidly expiring timestamp which allows the payer and the payee to conduct the electronic transaction in a secure and cost effective way.

In a payment request transaction, the payee utilizes a registered account to login to the application software associated with the electronic device for initiating a request for payment. The payee submits the payment request information through the application software which is then transmitted to the application server. The application server generates a unique identifier in response to the payment request information. The unique identifier is received by the application software and the application software generates the machine readable barcode by encoding the unique identifier. The payee provides the machine readable barcode to the payer and the payer captures an image of the machine readable barcode utilizing the hand-held communication device. The hand-held communication device utilizes the application software to resolve the machine readable barcode into the unique identifier. The application server receives the unique identifier and resolves it into the payment request information which is then sent to the application software associated with the hand-held communication device. The payer confirms the payment request information and selects payment method. The unique identifier, payment method, and payer information are sent to the application server by the application software to process the real-time transaction. The machine readable barcode is generated with a rapidly expiring timestamp which allows the payee and the payer to conduct the electronic transaction in a secure and cost effective way.

Another aspect of the preferred embodiment provides a system for facilitating real-time transactions via a web application. The system comprises a hand-held communication device associated with a payer, an electronic device associated with a payee, and an application server associated with the web application.

In an electronic payment transaction, the hand-held communication device is adaptable to execute the web application utilizing a web browser wherein the web application is configured to generate a machine readable barcode. The electronic device is adaptable to execute the web application utilizing the web browser wherein the web application is also configured to scan a machine readable barcode. The application server is configured to facilitate the electronic payment between the hand-held communication device and the electronic device. The payer may utilize a registered account to login to the web application for initiating the electronic payment via the web browser. If not previously registered, an account to login to the application software may also be registered at the time of the transaction. The payment information may be transmitted from the web application to the application server. The application server may generate a unique identifier in response to the payment information from the web application. The unique identifier is received by the web application and the web application generates the machine readable barcode by encoding the unique identifier provided by the application server. The payer provides the machine readable barcode to the payee and the payee scans the machine readable barcode utilizing the electronic device. The payee utilizes the web browser to login to the web application to submit the machine readable barcode. The web application resolves the machine readable barcode into the unique identifier utilizing a barcode reader. The unique identifier and payee identity are sent to the application server by the web application to process the real-time transaction. The machine readable barcode is generated with a rapidly expiring timestamp which allows the payer and the payee to conduct the electronic transaction in a secure and cost effective way.

In a payment request transaction, the payee utilizes a registered account to login to the web application via the web browser for initiating a request for payment. The payee submits the payment request information through the web application which is then transmitted to the application server. The application server generates a unique identifier in response to the payment request information. The unique identifier is received by the web application and the web application generates the machine readable barcode by encoding the unique identifier. The payee provides the machine readable barcode to the payer and the payer captures an image of the machine readable barcode utilizing the hand-held communication device. The hand-held communication device utilizes the web application via the web browser to resolve the machine readable barcode into the unique identifier. The application server receives the unique identifier and resolves it into the payment request information which is then sent to the web application. The payer confirms the payment request information and selects payment method. The unique identifier, payment method, and payer information are sent to the application server by the web application to process the real-time transaction. The machine readable barcode is generated with a rapidly expiring timestamp which allows the payee and the payer to conduct the electronic transaction in a secure and cost effective way.

Another embodiment provides a method for facilitating an electronic payment for real-time transactions via an application software in accordance with another aspect of the preferred embodiment of the present invention.

Another embodiment provides a method for facilitating an electronic payment for real-time transactions via a web application in accordance with another aspect of the preferred embodiment of the present invention.

One objective of the invention is to provide a system that provides an enhanced security to a payer.

Another objective of the invention is to provide an inexpensive means of electronic payment.

A third objective of the invention is to provide a system that does not require additional hardware.

Yet another objective of the invention is to provide a system that is portable.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a schematic diagram of a system for facilitating an electronic payment for real-time transactions via an application software in accordance with one aspect of a preferred embodiment of the present invention;

FIG. 2 is an operational flow chart of a method for facilitating an electronic payment for real-time transactions via an application software in accordance with the preferred embodiment of the present invention;

FIG. 3 is a schematic diagram of a system for facilitating an electronic payment for real-time transactions via a web application in accordance with another aspect of the preferred embodiment of the present invention;

FIG. 4 is an operational flow chart of a method for facilitating an electronic payment for real-time transactions via a web application in accordance with the aspect of the preferred embodiment of the present invention as described in FIG. 3;

FIG. 5 illustrates a hand-held communication device displaying a login page of the application software in accordance with the preferred embodiment of the present invention;

FIG. 6 illustrates a hand-held communication device displaying a registered account of the payer on the hand-held communication device in accordance with the preferred embodiment of the present invention;

FIG. 7 illustrates a payment information displayed on the hand-held communication device in accordance with the preferred embodiment of the present invention;

FIG. 8 illustrates a transaction information over a selected period of time, displayed on the hand-held communication device shown in accordance with the preferred embodiment of the present invention;

FIG. 9 illustrates a machine readable barcode displayed on the hand-held communication device in accordance with the preferred embodiment of the present invention;

FIG. 10 illustrates a barcode reader on the electronic device in accordance with the preferred embodiment of the present invention;

FIG. 11 is an operational flow chart of a method for facilitating a request for electronic payment for real-time transactions via an application software in accordance with the preferred embodiment of the present invention;

FIG. 12 is an operational flow chart of a method for facilitating a request for electronic payment for real-time transactions via a web application in accordance with the aspect of the preferred embodiment of the present invention as described in FIG. 3;

FIG. 13 illustrates a payment request information displayed on the electronic device in accordance with the preferred embodiment of the present invention; and

FIG. 14 illustrates a machine readable barcode displayed on the electronic device in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

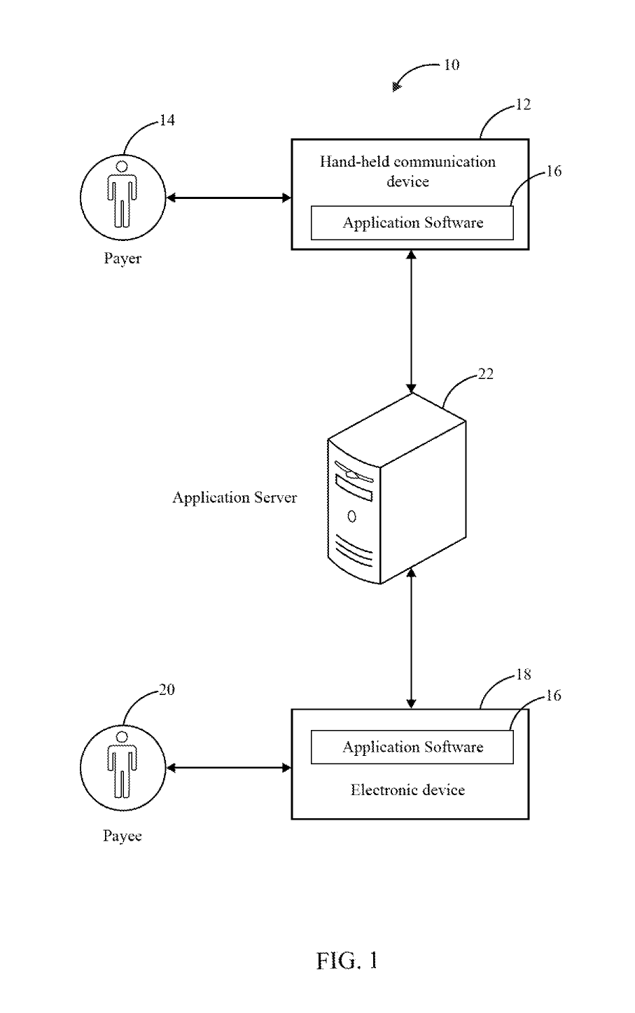

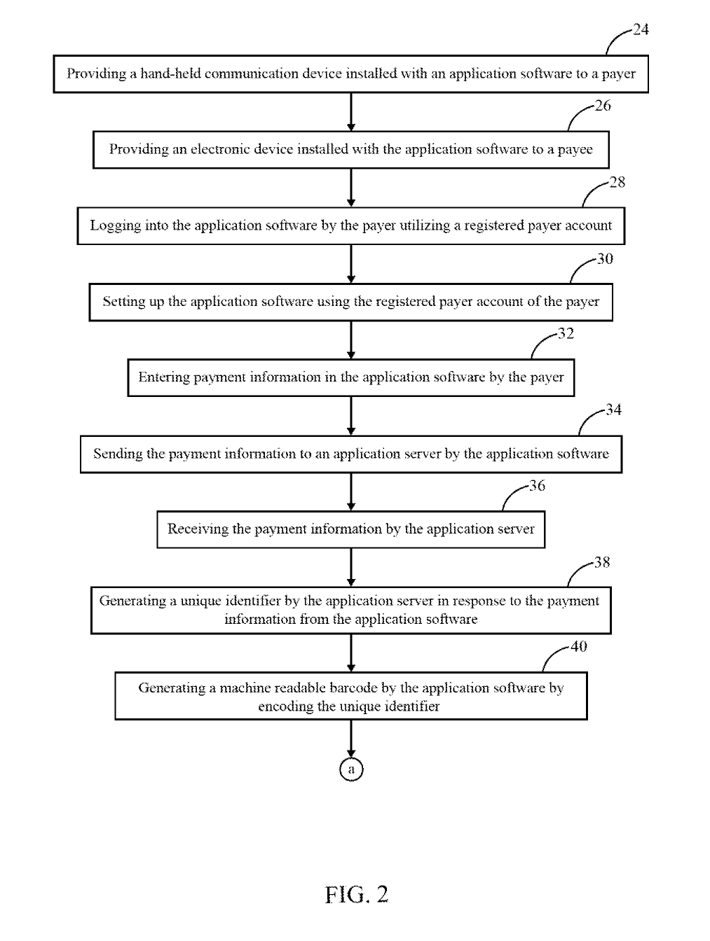

FIG. 1 is a schematic diagram of a system 10 for facilitating an electronic payment for real-time transactions via an application software 16 in accordance with one aspect of a preferred embodiment of the present invention. The system 10 comprises a hand-held communication device 12 associated with a payer 14, an electronic device 18 associated with a payee 20 and an application server 22 associated with the application software 16. The hand-held communication device 12 is adaptable to execute the application software 16 that is configured to generate a machine readable barcode (not shown). The electronic device 18 is also adaptable to execute the application software 16 wherein the application software 16 is configured to scan the machine readable barcode. The application server 22 is configured to facilitate the electronic payment between the hand-held communication device 12 and the electronic device 18. The machine readable barcode is generated with a rapidly expiring timestamp which allows the payer 14 to conduct the electronic payment with the payee 20 in a secure and cost effective way.

The payer 14 may utilize a registered account (not shown) to login to the application software 16 for initiating the electronic payment. The registered account may include payment information, shipping information, security and transaction information. The payment information may include payer identity, amount of payment and method of payment. The payment information may be transmitted from the application software 16 to the application server 22. The application server 22 generates a unique identifier (not shown) in response to the payment information from the application software 16. The unique identifier is received by the application software 16 and the application software 16 generates the machine readable barcode (not shown) by encoding the unique identifier. The payer 14 provides the machine readable barcode to the payee 20. The payee 20 scans the machine readable barcode utilizing the electronic device 18. The electronic device 18 utilizes the application software 16 to resolve the machine readable barcode into the unique identifier. The application software 16 may utilize a barcode reader (not shown) to resolve the machine readable barcode. The unique identifier and payee identity are sent to the application server 22 by the application software 16 to process the electronic payment.

The payee 20 may utilize a registered account (not shown) to access the application software 16. The hand-held communication device 12 may be selected from a group consisting of: cell phones, smart phones and I-phones. The electronic device 18 may be selected from a group consisting of: industrial scanners, mobile phones, smart phones and I-phones. Alternatively, the electronic device 18 may be a scanner with keypad, a scanner connected to a computer system or a scanner connected to a laptop. The electronic device 18 may include a keypad (not shown). The keypad may allow the payee 20 to enter an amount to be paid by the payer 14. The payer 14 can then confirm the amount by receiving a message from the application server 22 on the hand-held communication device 12.

The system 10 may be used for a wide range of electronic payments such as making payments at Point of Sale (POS) terminals, vending machines, restaurants, toll booths, parking meters, retailers, and person to person payments. The system 10 can also be used to encode cards such as library cards, retail store cards, grocery store cards and rewards. The system 10 is portable and is easy for anyone to use. The system 10 does not require any ecosystem infrastructure changes. Further, the system 10 does not require any additional hardware and is inexpensive. Moreover, the system 10 does not require any additional industry standards.

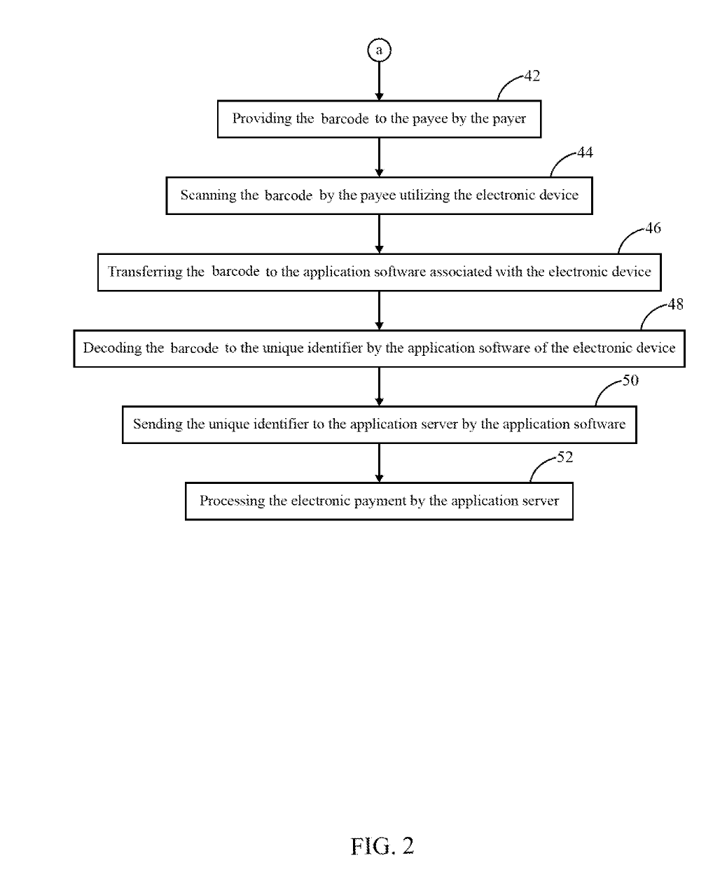

FIG. 2 is an operational flow chart of a method for facilitating an electronic payment for real-time transactions via an application software in accordance with the preferred embodiment of the present invention. A hand-held communication device installed with an application software is provided to a payer as indicated at block 24. An electronic device installed with the application software is provided to a payee as shown in block 26. The payer then logs into the application software utilizing a registered account as indicated at block 28. The application software is set up using the registered account of the payer as indicated at block 30. Payment information is entered in the application software by the payer as shown in block 32. The payment information is then sent to an application server by the application software as indicated at block 34. The payment information is received by the application server as indicated at block 36. A unique identifier is then generated by the application server in response to the payment information from the application software as shown in block 38. A machine readable barcode is generated by the application software by encoding the unique identifier as indicated at block 40. The machine readable barcode is provided to the payee by the payer as shown in block 42. The machine readable barcode is scanned by the payee utilizing the electronic device as indicated at block 44. The machine readable barcode is then transferred to the application software associated with the electronic device as indicated at block 46. The machine readable barcode is then decoded to the unique identifier by the application software of the electronic device as indicated at block 48. The unique identifier is then sent to the application server by the application software as shown in block 50. The electronic payment is then processed by the application server as shown in block 52.

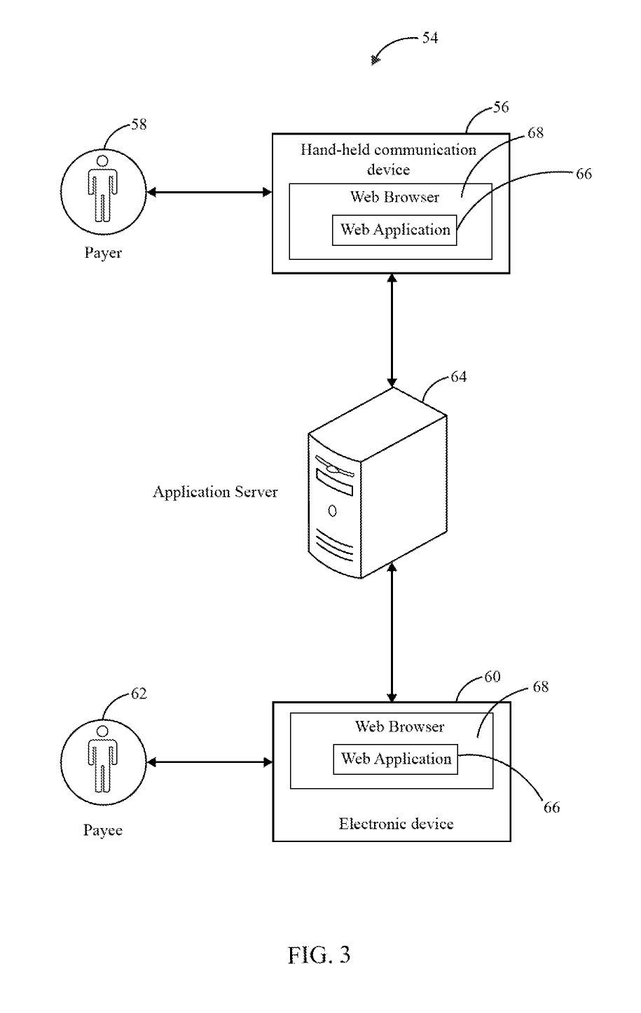

FIG. 3 is a schematic diagram of a system 54 for facilitating an electronic payment for real-time transactions via a web application 66 in accordance with another aspect of the preferred embodiment of the present invention. The system 54 comprises a hand-held communication device 56 associated with a payer 58, an electronic device 60 associated with a payee 62 and an application server 64 associated with the web application 66. The hand-held communication device 56 is adaptable to execute the web application 66 utilizing a web browser 68 wherein the web application 66 is configured to generate a machine readable barcode (not shown). The electronic device 60 is also adaptable to execute the web application 66 utilizing the web browser 68 wherein the web application 66 is configured to scan the machine readable barcode. The application server 64 is configured to facilitate the electronic payment between the hand-held communication device 56 and the electronic device 60. The machine readable barcode is generated with a rapidly expiring timestamp which allows the payer 58 to conduct the electronic payment with the payee 62 in a secure and cost effective way.

The payer 58 may utilize a registered account (not shown) to login to the web application 66 for initiating the electronic payment via the web browser 68. The registered account may include payment information, shipping information, security and transaction information. The payment information (not shown) may include payer identity, amount of payment and method of payment. The payment information may be transmitted from the web application 66 to the application server 64. The application server 64 may generate a unique identifier (not shown) in response to the payment information from the web application 66. The unique identifier is received by the web application 66 and the web application 66 generates the machine readable barcode (not shown) by encoding the unique identifier provided by the application server 64. The payer 58 provides the machine readable barcode to the payee 62 and the payee 62 scans the machine readable barcode utilizing the electronic device 60. The payee 62 utilizes the web browser 68 to login to the web application 66 to submit the machine readable barcode. The machine readable barcode is a one-time generated code. The web application 66 resolves the machine readable barcode into the unique identifier utilizing a barcode reader (not shown). The unique identifier and payee identity is sent to the application server 64 by the web application 66 to process the electronic payment.

The payee 62 may utilize a registered account to access the web application 66. The hand-held communication device 56 may be selected from a group consisting of: cell phones, smart phones and I-phones. The electronic device 60 may be selected from a group consisting of: industrial scanners, mobile phones, smart phones and I-phones. Alternatively, the electronic device 60 may be a scanner with keypad, a scanner connected to a computer system or a scanner connected to a laptop. The electronic device 60 may include a keypad (not shown). The keypad may allow the payee 62 to enter an amount to be paid by the payer 58. The payer 58 can then confirm the amount by receiving a message from the application server 64 on the hand-held communication device 56.

The system 54 may be used for a wide range of electronic payments such as making payments at Point of Sale (POS) terminals, vending machines, restaurants, toll booths, parking meters and person to person payments. The system 54 can also be used to encode cards such as library cards, retail store cards, grocery store cards and rewards. The system 54 is portable and easy for anyone to use. Further, the system 54 is inexpensive and does not require any additional hardware. Moreover, the system 54 does not require any additional industry standards and ecosystem infrastructure changes.

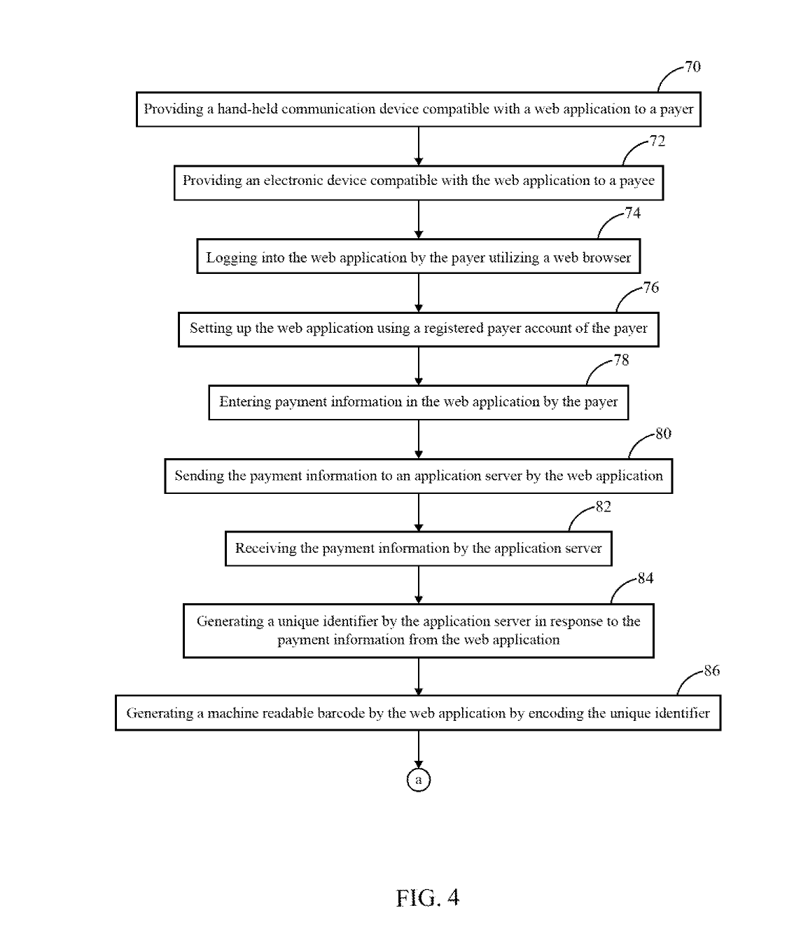

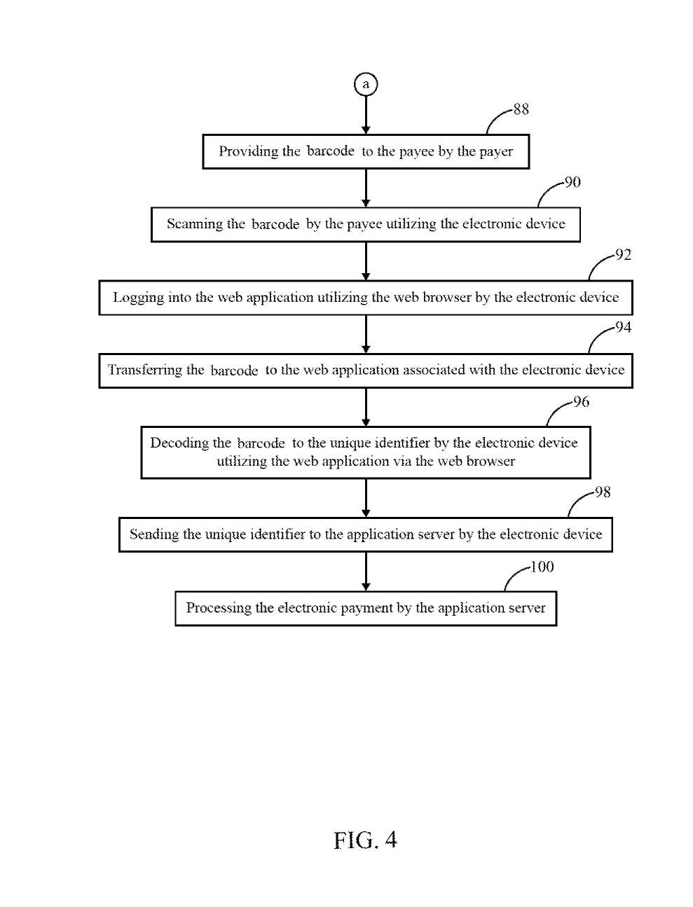

FIG. 4 is an operational flow chart of a method for facilitating an electronic payment for real-time transactions via a web application in accordance with the aspect of the preferred embodiment of the present invention as described in FIG. 3. A hand-held communication device compatible with a web application is provided to a payer as indicated at block 70. An electronic device compatible with the web application is provided to a payee as indicated at block 72. The payer logs into the web application utilizing a web browser as shown in block 74. The web application is set up using a registered account of the payer as indicated at block 76. Payment information is entered in the web application by the payer as shown in block 78. The payment information is then sent to an application server by the web application as indicated at block 80. The payment information is received by the application server as shown in block 82. A unique identifier is generated by the application server in response to the payment information from the web application as shown in block 84. A machine readable barcode is generated by the web application by encoding the unique identifier as indicated at lock 86. The machine readable barcode is provided to the payee by the payer as indicated at block 88. The machine readable barcode is scanned by the payee utilizing the electronic device as shown in block 90. The payee logs into the web application of the electronic device utilizing the web browser as shown in block 92. The machine readable barcode is then transferred to the web application associated with the electronic device as shown in block 94. The machine readable barcode is decoded to the unique identifier by the electronic device utilizing the web application via the web browser as indicated at block 96. The unique identifier is sent to the application server by the electronic device as indicated at block 98. The electronic payment is then processed by the application server as shown in block 100.

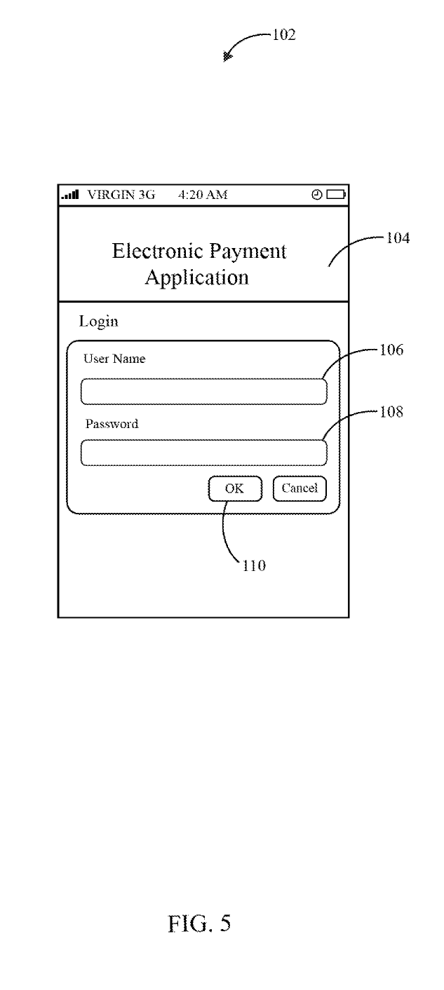

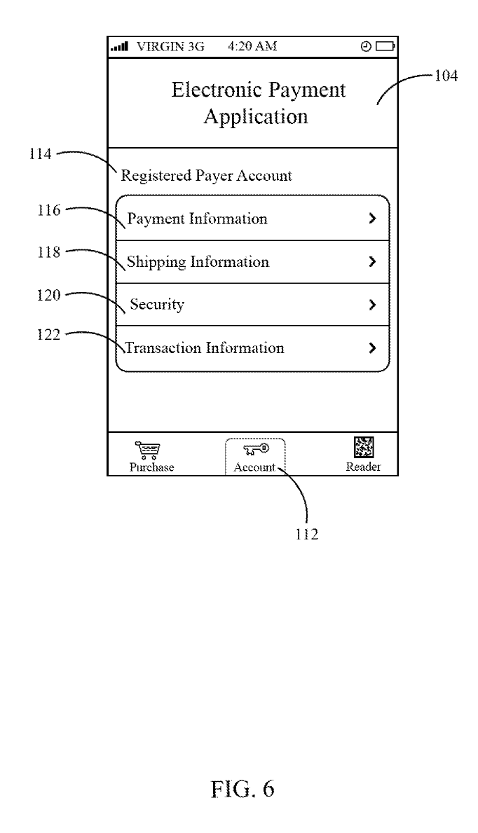

FIG. 5 illustrates a hand-held communication device displaying a login page 102 of an electronic payment application 104 in accordance with the preferred embodiment of the present invention. The hand-held communication device (12, 56) can be any phone which can display an image and run the electronic payment application 104. For instance, the electronic payment application 104 may be the application software 16 or the web application 66. The payer (14, 58) logs into the electronic payment application 104 utilizing a username 106 and a password 108. After entering the username 106 and password 108, the payer may press the OK button 110 to login to the electronic payment application 104.

FIG. 6 illustrates a hand-held communication device (12, 56) displaying a registered account 114 of the payer (14, 58) in accordance with the preferred embodiment of the present invention the electronic payment application 104. The payer (14, 58) may press the Account button 112 to retrieve the registered account 114. The payer (14, 58) may utilize the registered account 114 to login to the electronic payment application 104 for initiating the electronic payment. The registered account 114 may include payment information 116, shipping information 118, security 120 and transaction information 122. The payment information 116 may include payer identity, amount of payment and method of payment. The shipping information 118 allows the payer (14, 58) to perform shipping by providing the details such as name and address for making payments. The security option 120 of the registered account 114 may allow the payer (14, 58) to change the existing password, to provide new password and to verify the new password.

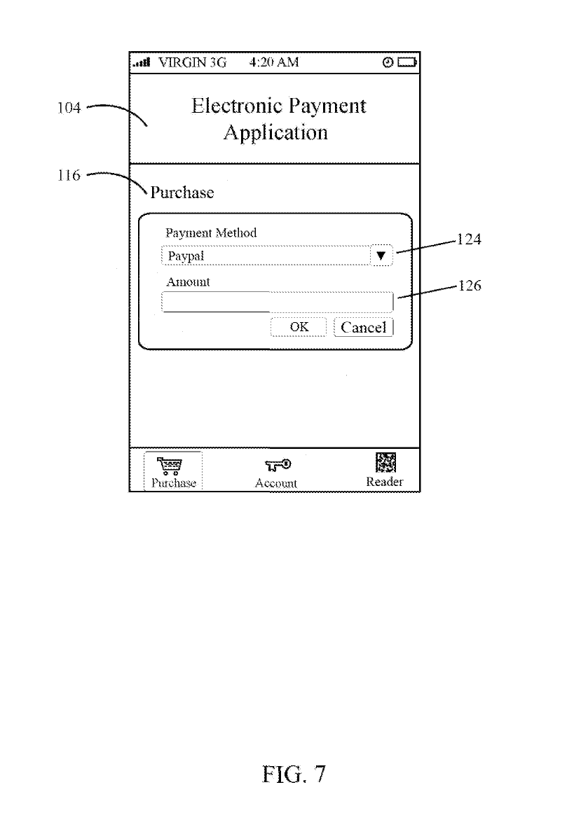

FIG. 7 illustrates a payment information 116 displayed on the hand-held communication device (12, 56) in accordance with the preferred embodiment of the present invention. The method of payment may be selected by the payer (14, 58) from a drop down menu 124 which may include options such as PayPal, credit card, and Google checkout. The payer (14, 58) will enter the payment amount in the amount box 126.

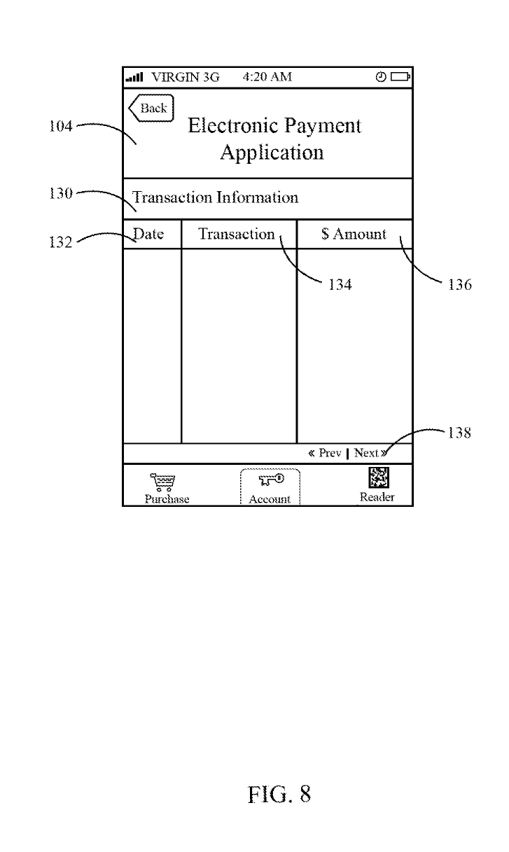

FIG. 8 illustrates a transaction information 130 over a selected period of time, displayed on the hand-held communication device (12, 56) shown in accordance with the preferred embodiment of the present invention. The payer (14, 58) can retrieve the transaction details 134 of the transaction performed over a selected period of time. The transaction information 130 provides the details of transactions such as date 132, transaction details 134 and amount of transaction 136 to the payer. The payer (14, 58) can view the previous and next transactions by pressing the Prev/Next button 138.

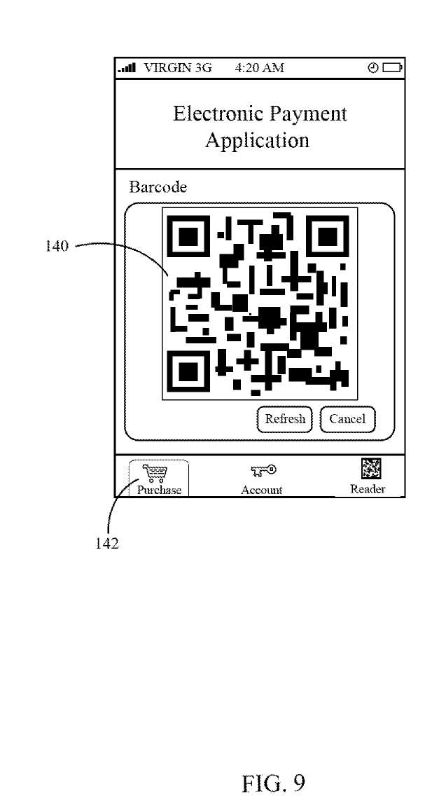

FIG. 9 illustrates a machine readable barcode 140 displayed on the hand-held communication device (12, 56). The payer (14, 58) can press the purchase button 142 to view the machine readable barcode 140. The payer (14, 58) can then provide the machine readable barcode to the payee. The machine readable barcode 140 is a dynamic, one-time generated code which represents a time-limited, fast expiring authorization for an electronic payment or payment request. The machine readable barcode 140 is generated by encoding a unique identifier into the machine readable barcode 140. The machine readable barcode 140 has a very short life (for example, 90 seconds). If an expired machine readable barcode is submitted, the transaction fails and a new machine readable barcode is required. The machine readable barcode 140 includes rapidly expiring timestamp which may be decoded only using special readers such as barcode reader.

The rapidly expiring timestamp associated with the machine readable barcodes helps to prevent unauthorized access thereby providing security to the payer (14, 58). Additionally, inability to duplicate the machine readable barcode 140 should be inherent by virtue of the unique identifier. The unique identifier (not shown) may be a 96 bits long random number. The system ensures an effective way of protection to the transaction since it is difficult to crack the 96 bits long random number within a short period of time such as 90 seconds. Thus, the rapidly expiring timestamp of the machine readable barcode 140 helps to prevent unauthorized access thereby providing an enhanced security to the payer (14, 58). The length of the unique identifier can further be increased by adding additional randomness.

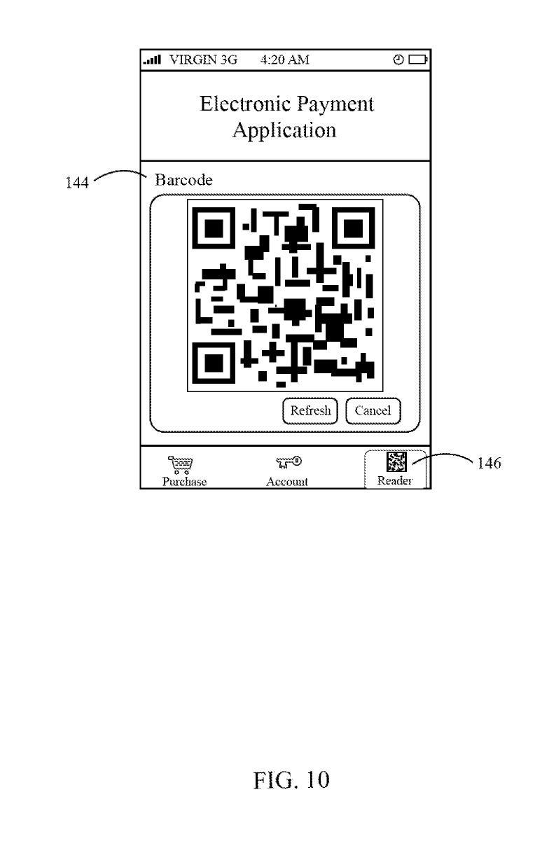

FIG. 10 illustrates a barcode reader 144 on the electronic device (18, 60). By selecting the barcode reader button 146 in the electronic device, the barcode reader 144 will be enabled in the electronic device (18, 60). The barcode reader 144 can resolve any machine readable barcode, including but not limited to any two-dimensional code capable of holding at least 64 characters 140. The barcode reader 144 is capable of resolving the machine readable barcode 140 into the unique identifier utilizing the electronic payment application 104.

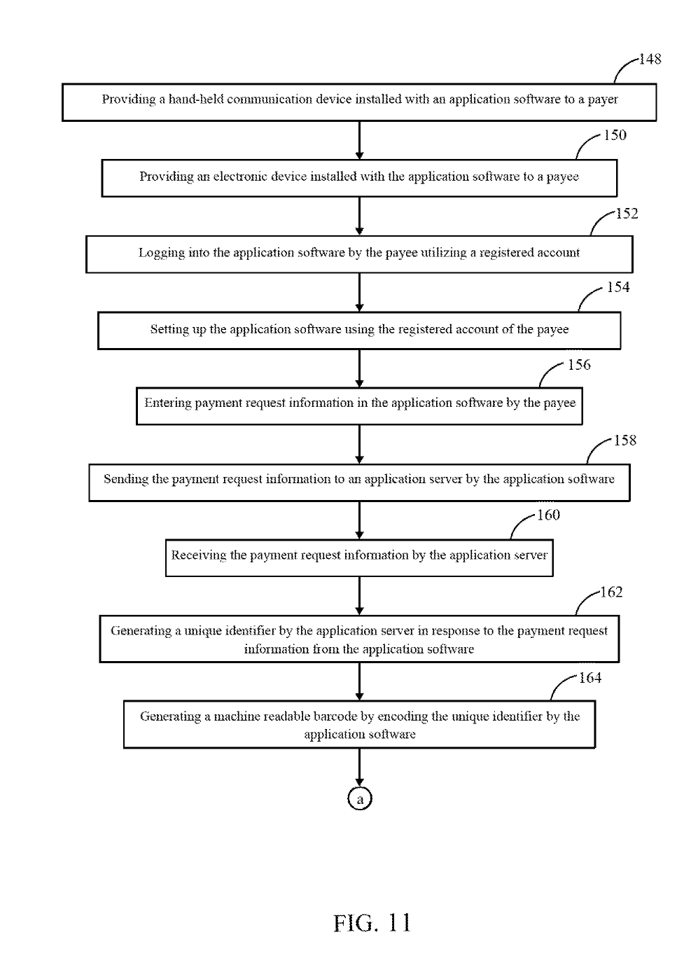

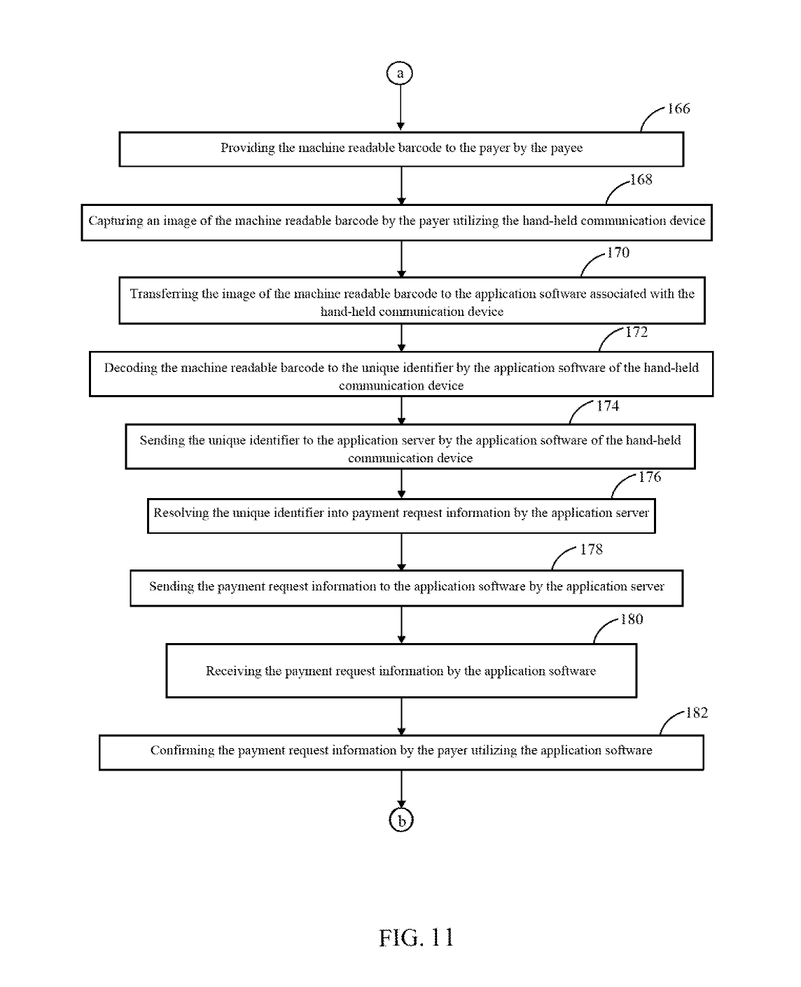

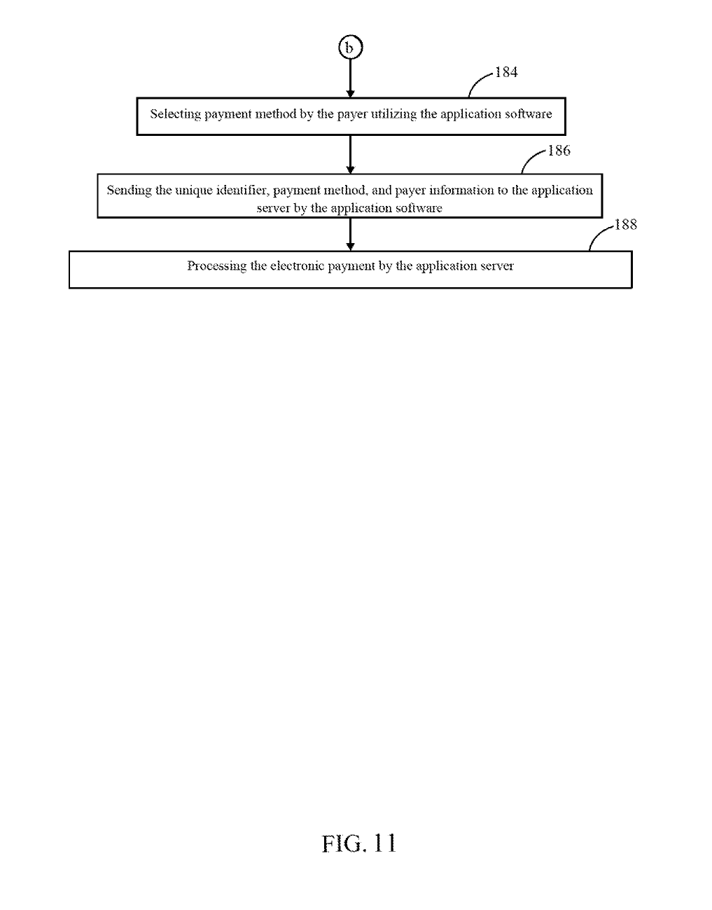

FIG. 11 is an operational flow chart of a method for facilitating a request for electronic payment for real-time transactions via an application software in accordance with the preferred embodiment of the present invention. A hand-held communication device installed with an application software is provided to a payer as indicated at block 148. An electronic device installed with the application software is provided to a payee as shown in block 150. The payee then logs into the application software utilizing a registered account as indicated at block 152. The application software is set up using the registered account of the payee as indicated at block 154. The registered account of the payee may include payment information, and payee's account information for receipt of the payment. Payment request information is entered in the application software by the payee as shown in block 156. Payment request information may include payee identity, directions, shipping information, and amount of payment. The payment request information is then sent to an application server by the application software as indicated at block 158. The payment request information is received by the application server as indicated at block 160. A unique identifier is then generated by the application server in response to the payment request information from the application software as shown in block 162. A machine readable barcode is generated by the application software by encoding the unique identifier as indicated at block 164. The machine readable barcode is provided to the payer by the payee as shown in block 166. An image of the machine readable barcode is captured by the payer utilizing the hand-held communication device as indicated at block 168. The image of the machine readable barcode is then transferred to the application software associated with the hand-held communication device as indicated at block 170. The machine readable barcode is then decoded to the unique identifier by the application software of the hand-held communication device as indicated at block 172. The unique identifier is then sent to the application server by the application software associated with the hand-held communication device as shown in block 174. The application server resolves the unique identifier into the payment request information 176 and sends the payment request information to the application software 178. The payment request information is received by the application software associated with the hand-held communication device 180. The payer confirms the payment request information utilizing the application software 182, and selects the method of payment from the list stored in the payer's registered account 184. The unique identifier, payment method information, and payer information are then submitted to the application server by the application software 186. The electronic payment is then processed by the application server as shown in block 188.

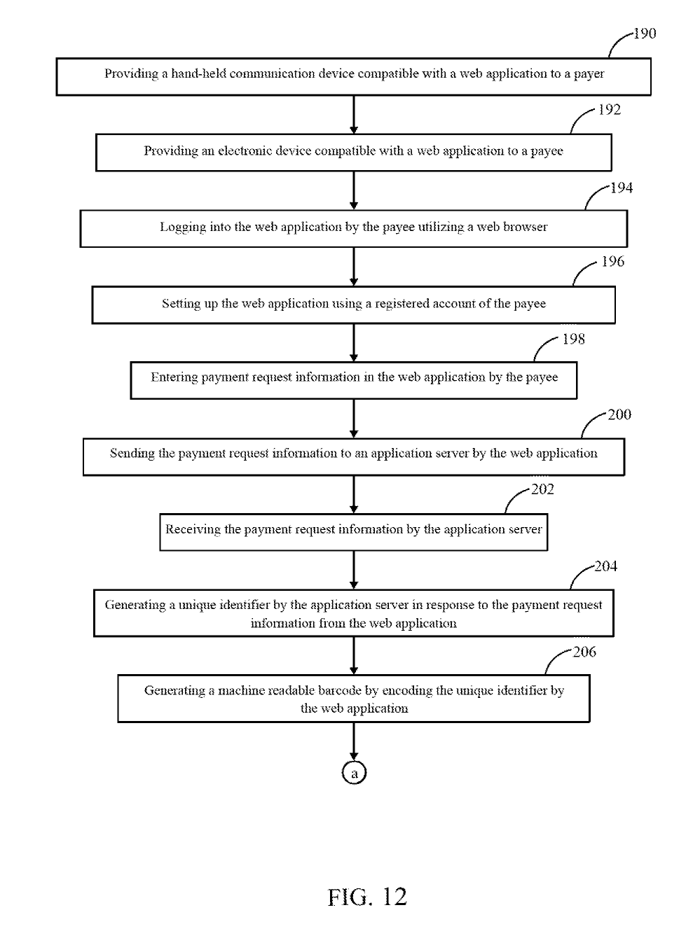

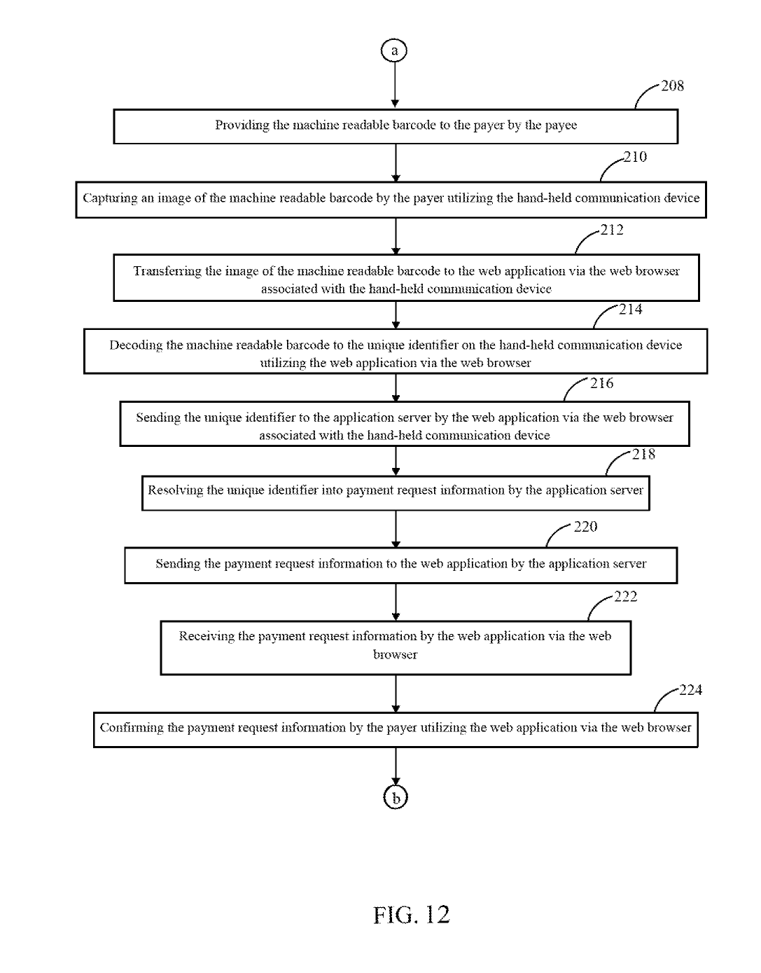

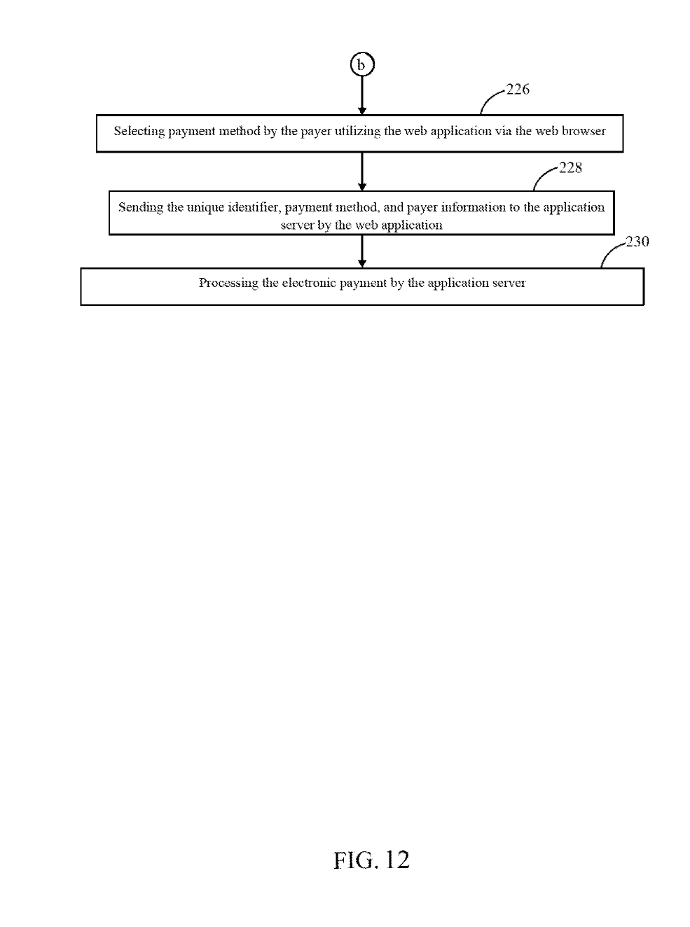

FIG. 12 is an operational flow chart of a method for facilitating a request for electronic payment for real-time transactions via a web application in accordance with the aspect of the preferred embodiment of the present invention as described in FIG. 3. A hand-held communication device compatible with a web application is provided to a payer as indicated at block 190. An electronic device compatible with the web application is provided to a payee as shown in block 192. The payee then logs into the web application utilizing a registered account as indicated at block 194. The web application is set up using the registered account of the payee as indicated at block 196. The registered account of the payee may include payment information, and payee's account information for receipt of the payment. Payment request information is entered in the web application by the payee as shown in block 198. Payment request information may include payee identity, directions, shipping information, and amount of payment. The payment request information is then sent to an application server by the web application as indicated at block 200. The payment request information is received by the application server as indicated at block 202. A unique identifier is then generated by the application server in response to the payment request information from the web application as shown in block 204. A machine readable barcode is generated by the web application by encoding the unique identifier as indicated at block 206. The machine readable barcode is provided to the payer by the payee as shown in block 208. An image of the machine readable barcode is captured by the payer utilizing the hand-held communication device as indicated at block 210. The image of the machine readable barcode is then uploaded to the web application associated with the hand-held communication device as indicated at block 212. The machine readable barcode is then decoded to the unique identifier by the web application of the hand-held communication device as indicated at block 214. The unique identifier is then sent to the application server by the web application associated with the hand-held communication device as shown in block 216. The application server resolves the unique identifier into the payment request information 218 and sends the payment request information to the web application 220. The payment request information is received by the web application associated with the hand-held communication device 222. The payer confirms the payment request information utilizing the web application 224, and selects the method of payment from the list stored in the payer's registered account 226. The unique identifier, payment method information, and payer information are then submitted to the application server by the web application 228. The electronic payment is then processed by the application server as shown in block 230.

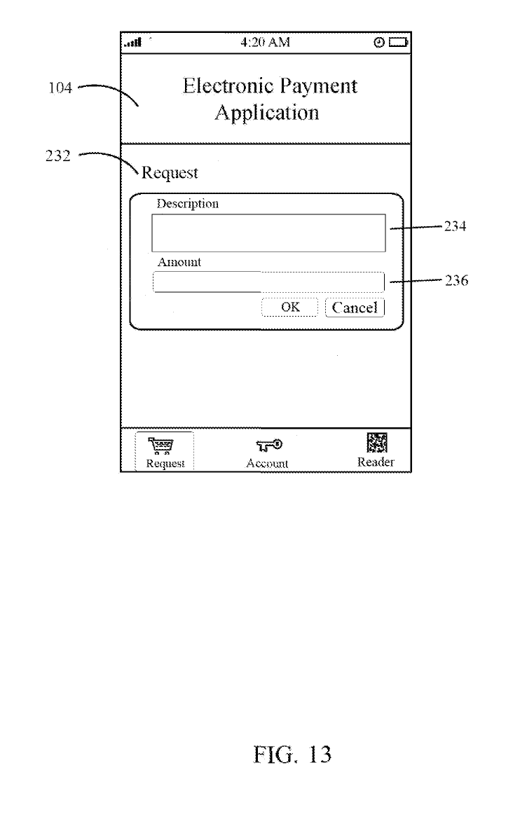

FIG. 13 illustrates a payment request information 232 displayed on the electronic device (18, 60) in accordance with the preferred embodiment of the present invention. A description 234 for the payment request and the payment amount 236 are entered by the payee (20, 62).

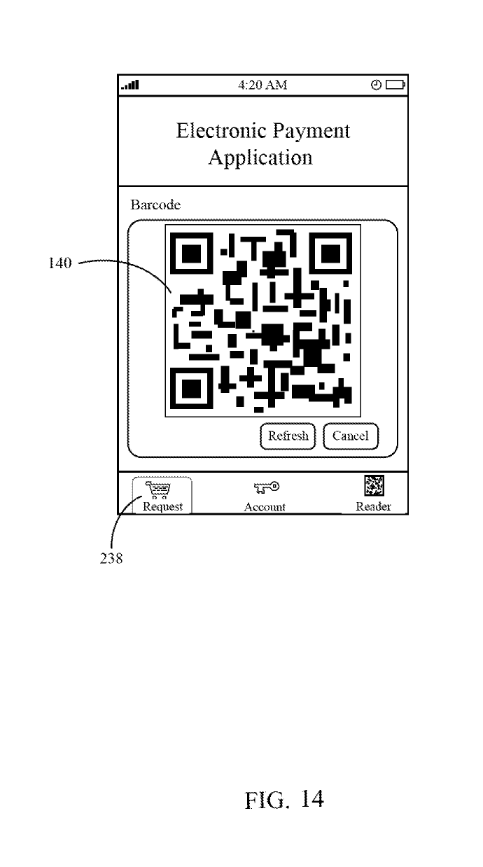

FIG. 14 illustrates a machine readable barcode 140 displayed on the electronic device (12, 56). The payee (20, 62) can press the request button 238 to view the machine readable barcode 140. The payee (20, 62) can then provide the machine readable barcode to the payer.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the electronic payment application 104 can be implemented as the application software 16 or the web application 66. Further, both the application software 16 and the web application 66 can be used interchangeably throughout the process. In addition, the system (10, 54) is designed as a Bring Forward (BF) system which is compatible to include new pluggable codes and data types to perform actions such as purchasing of tickets, ordering food at restaurants, encoding digital coupons and to include add- on standards such as encoding Vehicle Identification Number(VIN) of vehicles, encoding International Standard Book Number (ISBN) of books, and encoding Universal Product Code (UPC) labels without modifying the electronic payment application. It is intended that the scope of the present invention not be limited by this detailed description, but by the claims and the equivalents to the claims appended hereto.

What is claimed is:

1. A system for facilitating an electronic payment for real-time transactions via an application software, the system comprising:
a hand-held communication device associated with a payer, the hand-held communication device being adaptable to execute the application software, the application software being configured to generate a machine readable barcode;
an electronic device associated with a payee, the electronic device being adaptable to execute the application software, the application software being configured to scan the machine readable barcode; and
an application server associated with the application software, the application server being configured to facilitate the electronic payment between the hand-held communication device and the electronic device;
whereby the machine readable barcode is generated with a rapidly expiring timestamp which allows the payer to conduct the electronic payment with the payee in a secure and cost effective way.

2. The system of claim 1 wherein the payer may utilize a registered account to login to the application software for initiating the electronic payment.

3. The system of claim 2 wherein the registered account may include payment information, shipping information, security and transaction information.

4. The system of claim 3 wherein the payment information may include payer identity, amount of payment and method of payment.

5. The system of claim 4 wherein the method of payment may be selected from a group consisting of: PayPal, credit card and Google checkout.

6. The system of claim 4 wherein the payment information may be transmitted from the application software to the application server.

7. The system of claim 6 wherein the application server generates a unique identifier in response to the payment information from the application software.

8. The system of claim 7 wherein the unique identifier is received by the application software.

9. The system of claim 8 wherein the application software generates the machine readable barcode by encoding the unique identifier provided by the application server.

10. The system of claim 9 wherein the payer provides the machine readable barcode to the payee.

11. The system of claim 1 wherein the hand-held communication device may be selected from a group consisting of: cell phones, smart phones and I-phones.

12. The system of claim 1 wherein the electronic device may be selected from a group consisting of: industrial scanners, mobile phones, smart phones and I-phones.

13. The system of claim 1 wherein the payee scans the machine readable barcode utilizing the electronic device.

14. The system of claim 13 wherein the electronic device resolves the machine readable barcode into the unique identifier utilizing the application software.

15. The system of claim 13 wherein the payee may utilize a registered account to access the application software.

16. The system of claim 14 wherein the application software may utilize a barcode reader to resolve the machine readable barcode.

17. The system of claim 14 wherein the unique identifier and payee identity are sent to the application server by the application software to process the electronic payment.

18. The system of claim 1 wherein the electronic device may include a keypad.

19. The system of claim 18 wherein the keypad may allow the payee to enter an amount to be paid by the payer.

20. The system of claim 1 wherein the machine readable barcode is a one-time generated code.

21. The system of claim 1 wherein the rapidly expiring timestamp associated with the machine readable barcode is customizable.

22. The system of claim 1 wherein the system may be used for a wide range of electronic payments such as making payments at Point of Sale (POS) terminals, vending machines, restaurants, toll booths, parking meters, retailers, library cards, retail store cards and person to person payments.

23. The system of claim 1 wherein the system is portable.

24. A system for facilitating a request for electronic payment for real-time transactions via an application software, the system comprising:
an electronic device associated with a payee, the electronic device being adaptable to execute the application software, the application software being configured to generate a machine readable barcode;
a hand-held communication device associated with a payer, the hand-held communication device being adaptable to execute the application software, the application software being configured to read the machine readable barcode; and
an application server associated with the application software, the application server being configured to facilitate the electronic payment transaction between the hand-held communication device and the electronic device;
whereby the machine readable barcode is generated with a rapidly expiring timestamp which allows the payee to conduct the electronic payment transaction with the payer in a secure and cost effective way.

25. The system of claim 24 wherein the payee may utilize a registered account to login to the application software for initiating the payment request.

26. The system of claim 25 wherein the registered account may include payment request information, and payee's account information for receipt of the payment.

27. The system of claim 26 wherein the payment request information may include payee identity, description, shipping information, and amount of payment.

28. The system of claim 27 wherein the payment request information may be transmitted from the application software to the application server.

29. The system of claim 28 wherein the application server generates a unique identifier in response to the payment request information from the application software.

30. The system of claim 29 wherein the unique identifier is received by the application software.

31. The system of claim 30 wherein the application software generates the machine readable barcode by encoding the unique identifier provided by the application server.

32. The system of claim 31 wherein the payee provides the machine readable barcode to the payer.

33. The system of claim 24 wherein the electronic device may be selected from a group consisting of: industrial scanners, mobile phones, smart phones and I-phones.

34. The system of claim 24 wherein the hand-held communication device may be selected from a group consisting of: cell phones, smart phones and I-phones.

35. The system of claim 24 wherein the payer captures an image of the machine readable barcode utilizing the hand-held communication device.

36. The system of claim 24 wherein the payer may utilize a registered account to access the application software to transfer the machine readable barcode.

37. The system of claim 35 wherein the hand-held communication device resolves the machine readable barcode into the unique identifier utilizing the application software.

38. The system of claim 37 wherein the application software may utilize a barcode reader to resolve the machine readable barcode.

39. The system of claim 38 wherein the application software displays the payment request information to the payer.

40. The system of claim 39 wherein the unique identifier, payment method and payer information are sent to the application server by the application software to process the electronic payment.

41. The system of claim 40 wherein the method of payment may be selected from a group consisting of: PayPal, credit card and Google checkout.

42. The system of claim 24 wherein the electronic device may include a keypad.

43. The system of claim 42 wherein the keypad may allow the payee to enter an amount to be paid by the payer.

44. The system of claim 24 wherein the machine readable barcode is a one-time generated code.

45. The system of claim 24 wherein the rapidly expiring timestamp associated with the machine readable barcode is customizable.

46. The system of claim 24 wherein the system may be used for a wide range of electronic payment transactions such as making payments at Point of Sale (POS) terminals, vending machines, restaurants, toll booths, parking meters, retailers, library cards, retail store cards and person to person payments.

47. The system of claim 24 wherein the system is portable.

48. A method for facilitating an electronic payment for real-time transactions via an application software, the method comprising the steps of:
(a) providing a hand-held communication device installed with an application software to a payer;
(b) providing an electronic device installed with the application software to a payee;
(c) logging into the application software by the payer utilizing a registered account;
(d) setting up the application software using the registered account of the payer;
(e) entering payment information in the application software by the payer;
(f) sending the payment information to an application server by the application software;
(g) receiving the payment information by the application server;
(h) generating a unique identifier by the application server in response to the payment information from the application software;
(i) generating a machine readable barcode by encoding the unique identifier by the application software;
(j) providing the machine readable barcode to the payee by the payer;
(k) scanning the machine readable barcode by the payee utilizing the electronic device;
(l) transferring the machine readable barcode to the application software associated with the electronic device;
(m) decoding the machine readable barcode to the unique identifier by the application software of the electronic device;
(n) sending the unique identifier to the application server by the application software; and
(o) processing the electronic payment by the application server.

49. The method of claim 48 wherein the step (c) further comprises: logging into the application software by the payer utilizing a username and a password.

50. The method of claim 48 wherein the step (1) further comprises: utilizing a registered account of the payee to transfer the machine readable barcode to the application software associated with the electronic device.

51. The method of claim 48 wherein the step (n) further comprises: sending the unique identifier together with a payee identity to the application server by the electronic device.

52. The method of claim 48 wherein the registered account may include payment information, shipping information, security and transaction information.

53. The method of claim 52 wherein the payment information may include payer identity, amount of payment and method of payment.

54. The method of claim 53 wherein the method of payment may be selected from a group consisting of: PayPal, credit card and Google checkout.

55. The method of claim 48 wherein the hand-held communication device may be selected from a group consisting of: cell phones, smart phones and I-phones.

56. The method of claim 48 wherein the electronic device may be selected from a group consisting of: industrial scanners, mobile phones, smart phones and I-phones.

57. The method of claim 48 wherein the electronic device may include a keypad.

58. The method of claim 57 wherein the keypad may allow the payee to enter an amount to be paid by the payer.

59. The method of claim 48 wherein the machine readable barcode is a one-time generated code.

60. The method of claim 48 wherein the machine readable barcode includes a rapidly expiring timestamp.

61. A method for facilitating a request for electronic payment for real-time transactions via an application software, the method comprising the steps of:
(a) providing a hand-held communication device installed with an application software to a payer;
(b) providing an electronic device installed with the application software to a payee;
(c) logging into the application software by the payee utilizing a registered account;
(d) setting up the application software using the registered account of the payee;
(e) entering payment request information in the application software by the payee;
(f) sending the payment request information to an application server by the application software;
(g) receiving the payment request information by the application server;
(h) generating a unique identifier by the application server in response to the payment request information from the application software;
(i) generating a machine readable barcode by encoding the unique identifier by the application software;
(j) providing the machine readable barcode to the payer by the payee;
(k) capturing an image of the machine readable barcode by the payer utilizing the hand-held communication device;
(l) transferring the image of the machine readable barcode to the application software associated with the hand-held communication device;
(m) decoding the machine readable barcode to the unique identifier by the application software of the hand-held communication device;
(n) sending the unique identifier to the application server by the application software of the hand-held communication device;
(o) resolving the unique identifier into payment request information by the application server;
(p) sending the payment request information to the application software by the application server;
(q) receiving the payment request information by the application software;
(r) confirming the payment request information by the payer utilizing the application software;
(s) selecting payment method by the payer utilizing the application software;
(t) sending the unique identifier, payment method, and payer information to the application server by the application software; and
(u) processing the electronic payment by the application server.

62. The method of claim 61 wherein the step (c) further comprises: logging into the application software by the payee utilizing a username and a password.

63. The method of claim 61 wherein the step (f) further comprises: sending the payment request information to the application server by the electronic device.

64. The method of claim 61 wherein the step (1) further comprises: logging into the application software by the payer utilizing a username and a password.

65. The method of claim 64 wherein the step (1) further comprises: utilizing the registered account of the payer to transfer the machine readable barcode to the application software associated with the hand-held communication device.

66. The method of claim 62 wherein the registered account of the payee may include payment request information, and payee's account information for receipt of the payment.

67. The method of claim 61 wherein the payment request information of step (e) may include payee identity, description, shipping information, and amount of payment.

68. The method of claim 61 wherein the hand-held communication device may be selected from a group consisting of: cell phones, smart phones and I-phones.

69. The method of claim 61 wherein the electronic device may be selected from a group consisting of: industrial scanners, mobile phones, smart phones and I-phones.

70. The method of claim 61 wherein the electronic device may include a keypad.

71. The method of claim 70 wherein the keypad may allow the payee to enter an amount to be paid by the payer.

72. The method of claim 61 wherein the machine readable barcode is a one-time generated code.

73. The method of claim 61 wherein the machine readable barcode includes a rapidly expiring timestamp.

74. A system for facilitating an electronic payment for real-time transactions via a web application, the system comprising:
a hand-held communication device associated with a payer, the hand-held communication device being adaptable to execute the web application utilizing a web browser, the web application being configured to generate a machine readable barcode;
an electronic device associated with a payee, the electronic device being adaptable to execute the web application utilizing the web browser, the web application being configured to scan the machine readable barcode; and
an application server associated with the web application, the application server being configured to facilitate the electronic payment between the hand-held communication device and the electronic device;
whereby the machine readable barcode is generated with a rapidly expiring timestamp which allows the payer to conduct the electronic payment with the payee in a secure and cost effective way.

75. The system of claim 74 wherein the payer may utilize a registered account to login to the web application for initiating the electronic payment via the web browser.

76. The system of claim 75 wherein the registered account may include payment information, shipping information, security and transaction information.

77. The system of claim 76 wherein the payment information may include payer identity, amount of payment and method of payment.

78. The system of claim 77 wherein the method of payment may be selected from a group consisting of: PayPal, credit card and Google checkout.

79. The system of claim 77 wherein the payment information may be transmitted from the web application to the application server.

80. The system of claim 79 wherein the application server may generate a unique identifier in response to the payment information from the web application.

81. The system of claim 80 wherein the unique identifier is received by the web application.

82. The system of claim 81 wherein the web application generates the machine readable barcode by encoding the unique identifier provided by the application server.

83. The system of claim 82 wherein the payer provides the machine readable barcode to the payee.

84. The system of claim 74 wherein the hand-held communication device may be selected from a group consisting of: cell phones, smart phones and I-phones.

85. The system of claim 74 wherein the electronic device may be selected from a group consisting of: industrial scanners, mobile phones, smart phones and I-phones.

86. The system of claim 74 wherein the payee scans the machine readable barcode utilizing the electronic device.

87. The system of claim 86 wherein the payee utilizes the web browser to login to the web application to submit the machine readable barcode.

88. The system of claim 87 wherein the payee may utilize a registered account to access the web application.

89. The system of claim 88 wherein the web application resolves the machine readable barcode into the unique identifier utilizing a barcode reader.

90. The system of claim 89 wherein the unique identifier and payee identity is sent to the application server by the web application to process the electronic payment.

91. The system of claim 74 wherein the electronic device may include a keypad.

92. The system of claim 91 wherein the keypad may allow the payee to enter an amount to be paid by the payer.

93. The system of claim 74 wherein the machine readable barcode is a one-time generated code.

94. The system of claim 74 wherein the rapidly expiring timestamp associated with the machine readable barcode is customizable.

95. The system of claim 74 wherein the system may be used for a wide range of electronic payments such as making payments at Point of Sale (POS) terminals, vending machines, restaurants, toll booths, parking meters, retailers, library cards, retail store cards and person to person payments.

96. The system of claim 74 wherein the system is portable.

97. A system for facilitating a request for electronic payment for real-time transactions via a web application, the system comprising:
an electronic device associated with a payee, the electronic device being adaptable to execute the web application utilizing the web browser, the web application being configured to generate a machine readable barcode;
a hand-held communication device associated with a payer, the hand-held communication device being adaptable to execute the web application utilizing a web browser, the web application being configured to read the machine readable barcode; and
an application server associated with the web application, the application server being configured to facilitate the electronic payment transaction between the hand-held communication device and the electronic device;
whereby the machine readable barcode is generated with a rapidly expiring timestamp which allows the payee to conduct the electronic payment transaction with the payer in a secure and cost effective way.

98. The system of claim 97 wherein the payee may utilize a registered account to login to the web application for initiating the payment request via the web browser.

99. The system of claim 98 wherein the registered account may include payment request information, and payee's account information for receipt of the payment.

100. The system of claim 99 wherein the payment request information may include payee identity, description, shipping information, and amount of payment.

101. The system of claim 100 wherein the payment request information may be transmitted from the web application to the application server.

102. The system of claim 101 wherein the application server may generate a unique identifier in response to the payment request information from the web application.

103. The system of claim 102 wherein the unique identifier is received by the web application.

104. The system of claim 103 wherein the web application generates the machine readable barcode by encoding the unique identifier provided by the application server.

105. The system of claim 104 wherein the payee provides the machine readable barcode to the payer.

106. The system of claim 97 wherein the hand-held communication device may be selected from a group consisting of: cell phones, smart phones and I-phones.

107. The system of claim 97 wherein the electronic device may be selected from a group consisting of: industrial scanners, mobile phones, smart phones and I-phones.

108. The system of claim 97 wherein the payer captures an image of the machine readable barcode utilizing the hand-held communication device.

109. The system of claim 108 wherein the payer utilizes the web browser to login to the web application to upload the machine readable barcode.

110. The system of claim 109 wherein the web application resolves the machine readable barcode into the unique identifier utilizing a barcode reader.

111. The system of claim 110 wherein the unique identifier, payment method, and payer identity are sent to the application server by the web application to process the electronic payment.

112. The system of claim 97 wherein the electronic device may include a keypad.

113. The system of claim 112 wherein the keypad may allow the payee to enter an amount to be paid by the payer.

114. The system of claim 97 wherein the machine readable barcode is a one-time generated code.

115. The system of claim 97 wherein the rapidly expiring timestamp associated with the machine readable barcode is customizable.

116. The system of claim 97 wherein the system may be used for a wide range of electronic payments such as making payments at Point of Sale (POS) terminals, vending machines, restaurants, toll booths, parking meters, retailers, library cards, retail store cards and person to person payments.

117. The system of claim 97 wherein the system is portable.

118. A method for facilitating an electronic payment for real-time transactions via a web application, the method comprising:
(a) providing a hand-held communication device compatible with a web application to a payer;
(b) providing an electronic device compatible with the web application to a payee;
(c) logging into the web application by the payer utilizing a web browser;
(d) setting up the web application using a registered account of the payer;
(e) entering payment information in the web application by the payer;
(f) sending the payment information to an application server by the web application;
(g) receiving the payment information by the application server;
(h) generating a unique identifier by the application server in response to the payment information from the web application;
(i) generating a machine readable barcode by encoding the unique identifier by the web application;
(j) providing the machine readable barcode to the payee by the payer;
(k) scanning the machine readable barcode by the payee utilizing the electronic device;
(l) logging into the web application utilizing the web browser by the electronic device;
(m) transferring the machine readable barcode to the web application associated with the electronic device;
(n) decoding the machine readable barcode to the unique identifier by the electronic device utilizing the web application via the web browser;
(o) sending the unique identifier to the application server by the electronic device; and
(p) processing the electronic payment by the application server.

119. The method of claim 118 wherein the step (c) further comprises: logging into the web application by the payer utilizing a username and a password.

120. The method of claim 118 wherein the step (m) further comprises: utilizing a registered account of the payee to transfer the machine readable barcode to the web application associated with the electronic device.

121. The method of claim 118 wherein the step (p) further comprises: sending the unique identifier together with a payee identity by the electronic device.

122. The method of claim 118 wherein the registered account may include payment information, shipping information, security and transaction information.

123. The method of claim 118 wherein the payment information may include payer identity, amount of payment and method of payment.

124. The method of claim 123 wherein the method of payment may be selected from a group consisting of: PayPal, credit card and Google checkout.

125. The method of claim 118 wherein the hand-held communication device may be selected from a group consisting of: cell phones, smart phones and I-phones.

126. The method of claim 118 wherein the electronic device may be selected from a group consisting of: industrial scanners, mobile phones, smart phones and I-phones.

127. The method of claim 118 wherein the electronic device may include a keypad.

128. The method of claim 127 wherein the keypad may allow the payee to enter amount to be paid by the payer.

129. The method of claim 118 wherein the machine readable barcode is a one-time generated code.

130. The method of claim 118 wherein the machine readable barcode includes a rapidly expiring timestamp.

131. A method for facilitating a request for electronic payment for real-time transactions via a web application, the method comprising:
(a) providing a hand-held communication device compatible with a web application to a payer;
(b) providing an electronic device compatible with the web application to a payee;
(c) logging into the web application by the payee utilizing a web browser;
(d) setting up the web application using a registered account of the payee;
(e) entering payment request information in the web application by the payee;
(f) sending the payment request information to an application server by the web application;
(g) receiving the payment request information by the application server;
(h) generating a unique identifier by the application server in response to the payment request information from the web application;
(i) generating a machine readable barcode by encoding the unique identifier by the web application;
(j) providing the machine readable barcode to the payer by the payee;
(k) capturing an image of the machine readable barcode by the payer utilizing the hand-held communication device;
(l) transferring the image of the machine readable barcode to the web application via the web browser associated with the hand-held communication device;
(m) decoding the machine readable barcode to the unique identifier on the hand-held communication device utilizing the web application via the web browser;
(n) sending the unique identifier to the application server by the web application via the web browser associated with the hand-held communication device;
(o) resolving the unique identifier into payment request information by the application server;
(p) sending the payment request information to the web application by the application server;
(q) receiving the payment request information by the web application via the web browser;
(r) confirming the payment request information by the payer utilizing the web application via the web browser;
(s) selecting payment method by the payer utilizing the web application via the web browser;
(t) sending the unique identifier, payment method, and payer information to the application server by the web application; and
(u) processing the electronic payment by the application server.

132. The method of claim 131 wherein the step (c) further comprises: logging into the web application by the payee utilizing a username and a password.

133. The method of claim 131 wherein the step (1) further comprises: logging into the web application by the payer utilizing a username and a password.

134. The method of claim 133 wherein the step (1) further comprises: utilizing the registered account of the payer to transfer the machine readable barcode to the web application via the web browser associated with the hand-held communication device.

135. The method of claim 132 wherein the registered account of the payee may include payment information, and payee's account information for receipt of the payment.

136. The method of claim 131 wherein the payment request information of step (e) may include payee identity, description, shipping information, and amount of payment.

137. The method of claim 131 wherein the hand-held communication device may be selected from a group consisting of: cell phones, smart phones and I-phones.

138. The method of claim 131 wherein the electronic device may be selected from a group consisting of: industrial scanners, mobile phones, smart phones and I-phones.

139. The method of claim 131 wherein the electronic device may include a keypad.

140. The method of claim 139 wherein the keypad may allow the payee to enter amount to be paid by the payer.

141. The method of claim 131 wherein the machine readable barcode is a one-time generated code.

142. The method of claim 131 wherein the machine readable barcode includes a rapidly expiring timestamp.
